(19) United States
(12) Patent Application Publication
(10) Pub. No.: US 2011/0003493 A1
(43) Pub. Date: Jan. 6, 2011

(54) USB MEMORY CARD HAVING AN INSULATOR FOR RETAINING RESELIENT CONTACTS

(75) Inventors: CHI-TUNG MO, Tu-Cheng (TW); MING-CHANG TSAI, Tu-Cheng (TW); JUI-CHI SU, Tu-Cheng (TW); YUH-HUEY KANG, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/830,354

(22) Filed: Jul. 5, 2010

(30) Foreign Application Priority Data
Jul. 3, 2009 (CN) 200910304007.1

(51) Int. Cl. H01R 12/00

(52) U.S. Cl. 439/81

(57) ABSTRACT

An USB memory card (100) for mating with a receptacle connector includes a PCB (1) having opposed upper and lower surfaces; a set of metal contacting pads (13) disposed on the upper surface of the PCB; a metal shell (5) enveloping the upper surface of the PCB and collaborating with the upper surface to form a receiving space (101) for receiving a tongue plate of the receptacle connector; and a metal film (15) covering the lower surface of the PCB.

### BACKGROUND OF THE INVENTION

1. Field of the Invention

The present invention relates to an USB memory card, and more particularly to an USB memory card having an insulator for retaining resilient contacts.

2. Description of Related Art

Rapid advances in technology in several areas have converged to enable small, portable memory cards with vast capacities. Flash memory technologies such as those using electrically-erasable programmable read-only memory (EEPROM) have produced chips storing 512 M-Bytes or more. Small flash-memory cards have been designed with a connector that can plug into a specialized reader, such as for compact-flash, secure-digital, memory stick, or other standardized formats. Recently, memory cards are being sold that contain an USB 2.0 connector. Such USB 2.0 memory cards do not require a specialized reader but can be plugged into an USB connector on a host system, such as a personal computer (PC). These USB 2.0 memory cards can be used in place of floppy disks. An USB 2.0 memory card can have a capacity of more than ten floppy disks in an area not much larger than a large postage stamp.

In 2008, USB 3.0 specification has been released for transmitting high speed rate. Therefore, a memory card with an USB 3.0 connector is needed to be designed to take place of the USB 2.0 memory card.

Hence, an improved USB memory card is desired to overcome the above problems.

### BRIEF SUMMARY OF THE INVENTION

According to one aspect of the present invention, an USB memory card comprises a printed circuit board defining opposite first and second surfaces, the printed circuit board having a plurality of passageways passing through said first and second surfaces; a plurality of metal contacting pads formed on the first surface of the printed circuit board and before said passageways in a front-to-back direction; and a contact module including an insulator secured to the printed circuit board, and a plurality of resilient contacts defining resilient contacting portions for being movable in the corresponding passageways along a height direction of the USB memory card, tail portions for being mounted to the printed circuit board, and connecting portions connecting the contacting portions and the tail portions for being retained in the insulator.

According to another aspect of the present invention, an USB 3.0 thin card comprises a printed circuit board defining a base portion and a tongue portion extending forwardly from the base portion, the tongue portion having a plurality of metal contacting pads disposed on an upper surface thereof, and a plurality of passageways passing therethrough in a height direction of the USB 3.0 thin card and located behind the metal contacting pads in a front-to-back direction; a contact module including an insulator disposed on a lower surface of the printed circuit board, and a plurality of resilient contacts comprising resilient contacting portions protruding upwardly into the corresponding passageways and beyond the upper surface of the printed circuit board, tail portions for being mounted to the printed circuit board, and connecting portions connecting the contacting portions and the tail portions for being retained in the insulator; and a shell covering the printed circuit board and the contact module with the metal contacting pads and the contacting portions exposed to exterior.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an USB memory card according to a first embodiment of the present invention;

FIG. 2 is a partly exploded perspective view of the USB memory card shown in FIG. 1;

FIG. 3 is similar to FIG. 2, but viewed from another aspect;

FIG. 4 is an exploded perspective view of the USB memory card shown in FIG. 1;

FIG. 5 is similar to FIG. 4, but viewed from another aspect;

FIG. 6 is a cross-sectional view of the USB memory card taken along line 6-6 shown in FIG. 1;

FIG. 7 is an assembled, perspective view of an USB memory card according to a second embodiment of the present invention;

FIG. 8 is an exploded perspective view of the USB memory card shown in FIG. 7.

FIG. 9 is a cross-sectional view of the USB memory card taken along line 9-9 shown in FIG. 7.

FIG. 10 is an assembled, perspective view of an USB memory card according to a third embodiment of the present invention;

FIG. 11 is an exploded perspective view of the USB memory card shown in FIG. 10;

FIG. 12 is a cross-sectional view of the USB memory card taken along line 12-12 shown in FIG. 10;

FIG. 13 is an assembled, perspective view of an USB memory card according to a fourth embodiment of the present invention;

FIG. 14 is an exploded perspective view of the USB memory card shown in FIG. 13; and

FIG. 15 is a cross-sectional view of the USB memory card taken along line 15-15 shown in FIG. 13.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

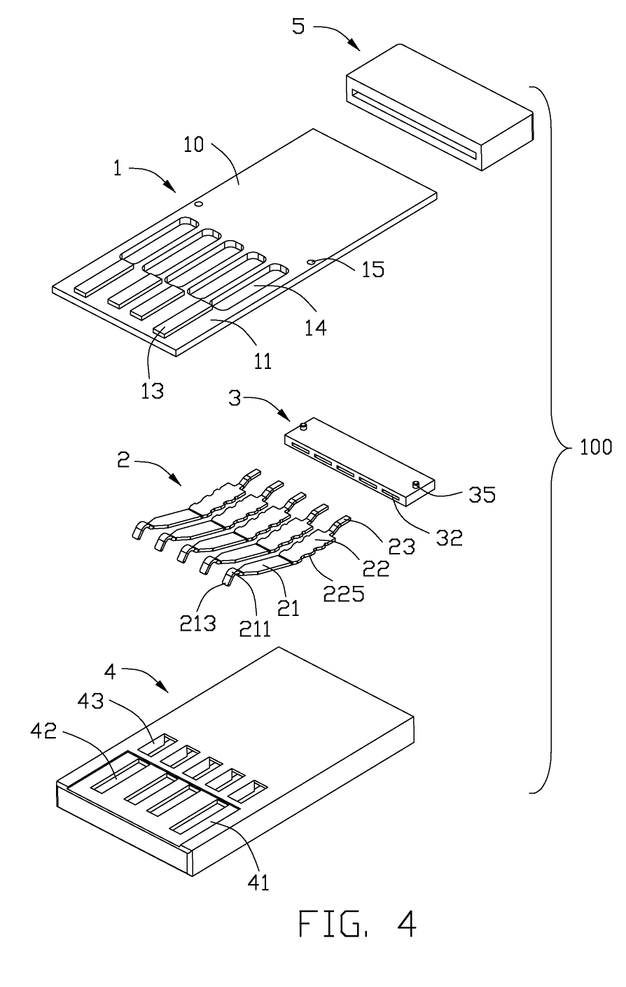

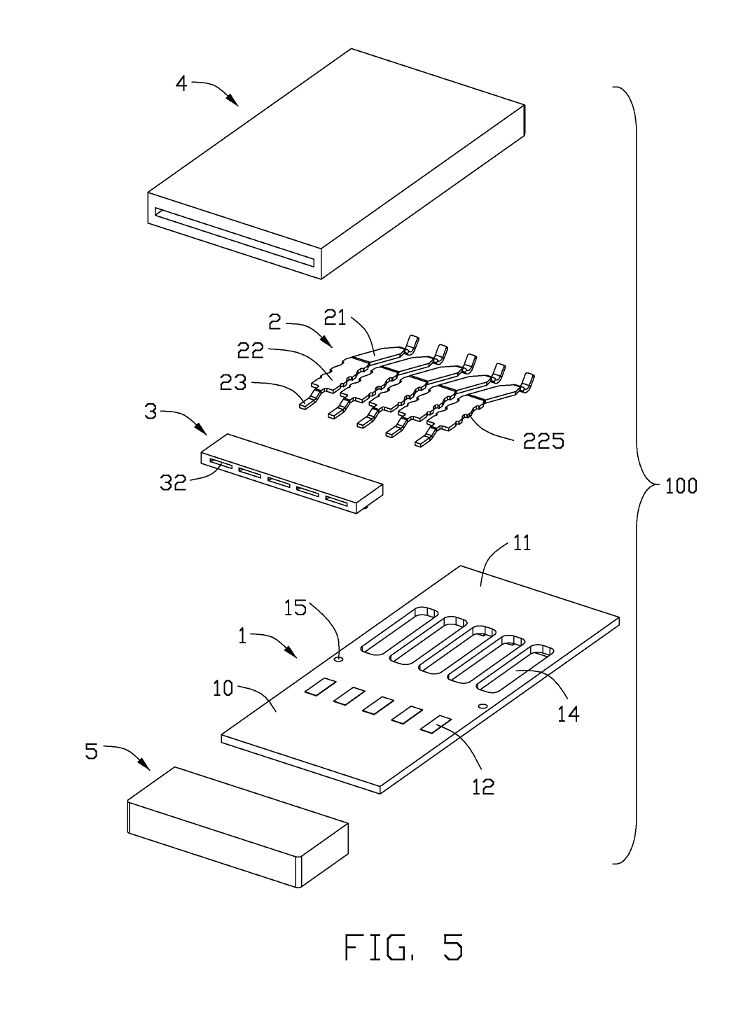

Referring to FIGS. 4 and 5, an USB memory card 100 according to a first embodiment of the present invention is adapted for mating with an USB 3.0 or USB 2.0 receptacle connector (not shown) and comprises a printed circuit board (named as PCB hereinafter) 1, a contact module coupled to the PCB 1, a shell 4 and a cover 5 covering the PCB 1 and the contact module.

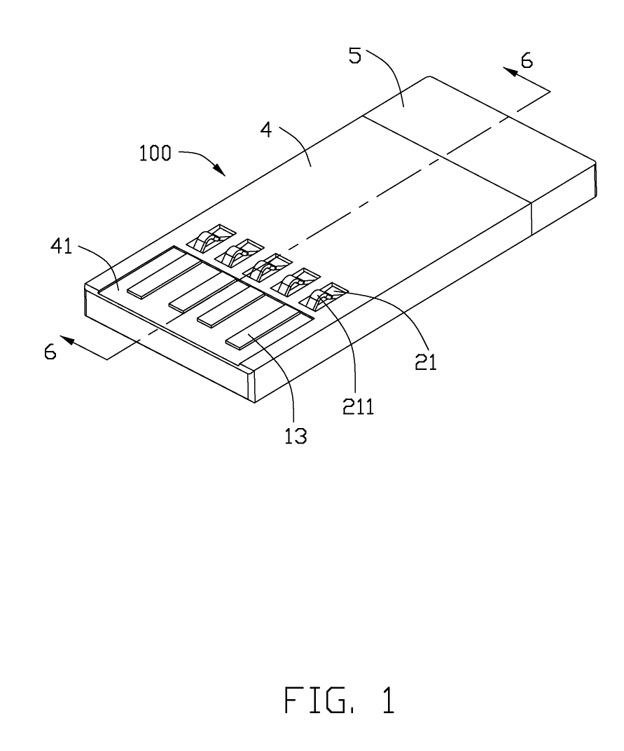

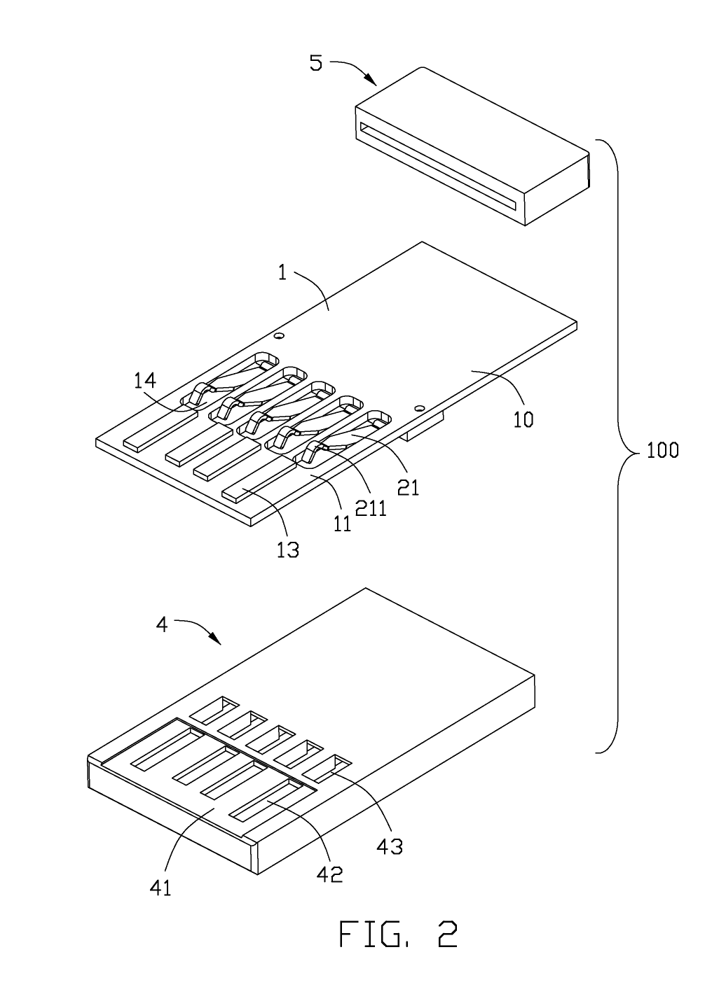

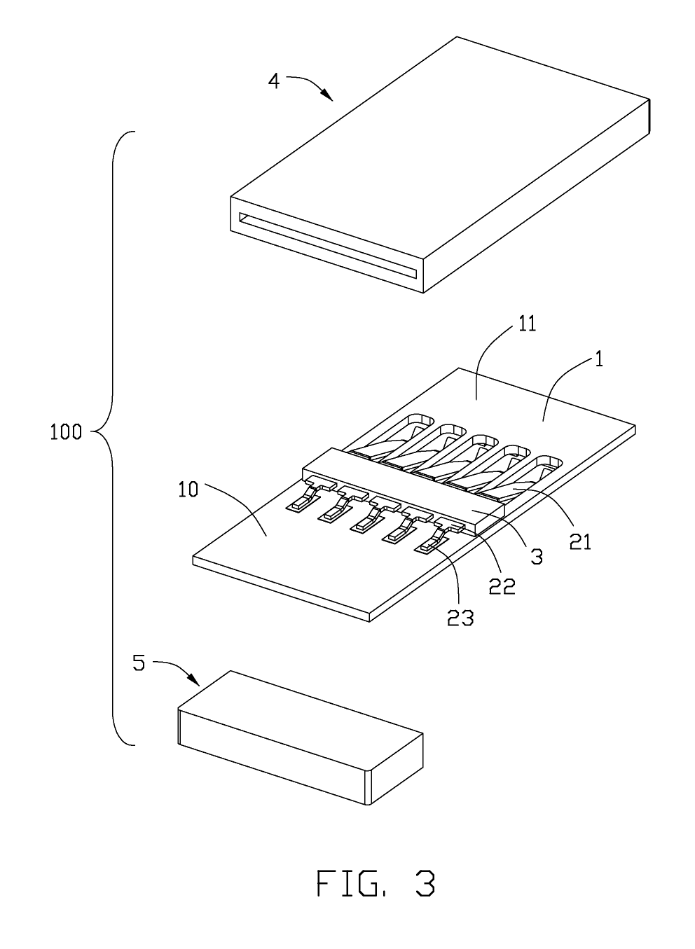

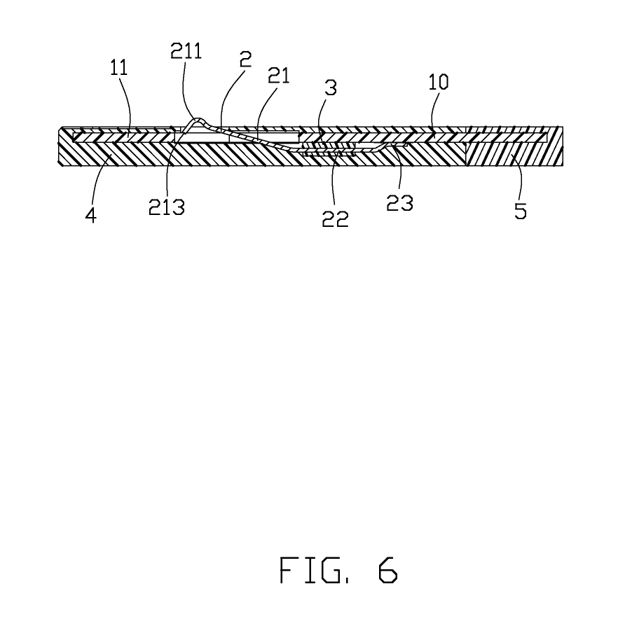

Referring to FIGS. 1-6, the PCB 1 includes a base portion 10 and a tongue portion 11 extending forwardly from a front end of the base portion 10. The base portion 10 defines a plurality of metal soldering pads 12 formed on a lower surface thereof and a pair of through holes 15 passing therethrough in a height direction of the USB memory card 100. The tongue portion 11 has a plurality of metal contacting pads 13 formed on an upper surface thereof and arranged in a front row along a transverse direction for mating with the receptacle connector, and a plurality of passageways 14 passing therethrough in the height direction and arranged in a back row along the transverse direction. The passageways 14 are located between the contacting pads 13 and the soldering pads 12. The contacting pads 13 are formed by golden fingers of the PCB 1.

The contact module includes an insulator 3 and a plurality of resilient contacts 2 coupled to the insulator 3. Each resilient contact 2 has a tail portion 23 for being soldered on the soldering pad 12, a resilient contacting portion 21 being movably received in the corresponding passageway 14 for mating with the receptacle connector, and a connecting portion 22 connecting the contacting portion 21 and the tail portion 23. The contacting portion 21 bends upwardly and extends forwardly from a front end of the connecting portion 22. The contacting portion 21 has an arc portion 211 bowed upwardly and protruding upwardly beyond the upper surface of the tongue portion 11. A free end portion 213 is located at a front end of the arc portion 211 for moving freely in the height direction of the USB memory card 100. The tail portion 23 bends upwardly and extends backwardly from a rear end of the connecting portion 22. The connecting portions 22 are assembled to a plurality of cavities 32 formed on the insulator 3, the insulator 3 is located between the passageways 14 and the soldering pads 12, a pair of posts 35 protrude upwardly from an upper surface of the insulator 3 for being retained into the through holes 15 of the PCB. therefore, the resilient contact 2 and the insulator 3 are formed together as the contact module for being assembled to the PCB 1, the tail portions 23 could be soldered on the soldering pads 12 securely, and when the resilient contacting portions 21 are deflected by the receptacle connector, the tail portions 23 will not be deflected and will electrically connect to the soldering pads 12 reliably. Each connecting portion 22 has a set of projections 225 projecting from two lateral sides thereof for interferentially engaging with the corresponding cavity 32.

The resilient contacts 2 comprise two pairs of differential contacts and a grounding contact located between the two pairs of differential contacts. The metal contacting pads 13 are adapted for USB 2.0 protocol. The metal contacting pads 13 and the resilient contacts 2 are commonly adapted for USB 3.0 protocol. The metal contacting pads 13 and the contacting portions 21 are located on the upper surface of the tongue portion 11 and are arranged in two rows along a front-to-back direction. In other embodiments, the connecting portions 22 of the resilient contacts 2 could be insert molded into the insulator 3 so that the resilient contacts 2 could be retained in the insulator 3 firmly. The USB memory card 100 using the PCB 1, the metal contacting pads 13 and the resilient contacts 2 to form as an USB 3.0 memory card will diminish the cost of production and miniaturize the volume of the USB memory card 100.

Referring to FIGS. 1-6, the shell 4 envelopes the insulator 3 and the tongue portion 11 for retaining the insulator 3 and the tongue portion 11 together. The shell 4 has a depression 41 recessed downwardly from an upper surface thereof and defining a plurality of first receiving slots 42 for exposing the metal contacting pads 13 to exterior, and a plurality of second receiving slots 43 locating behind the depression 41 for exposing the arc portions 211 of the resilient contacts 21 to the exterior.

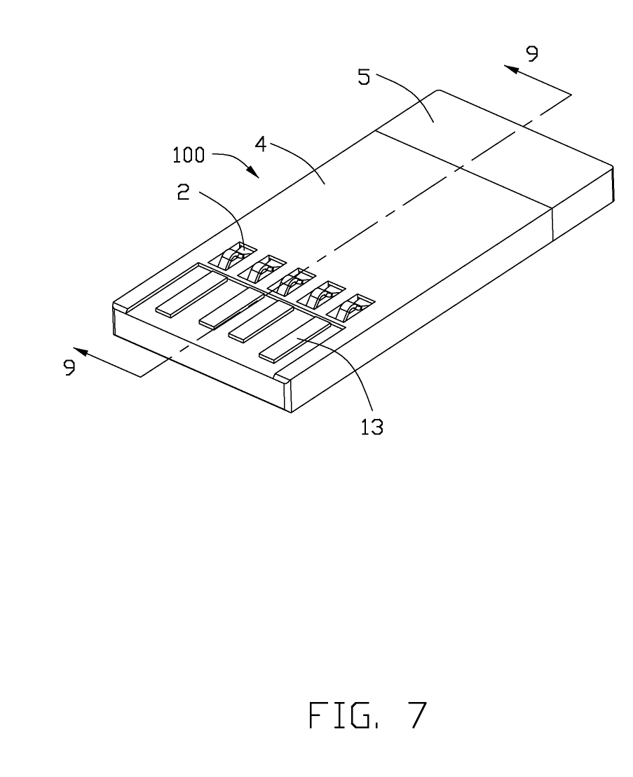

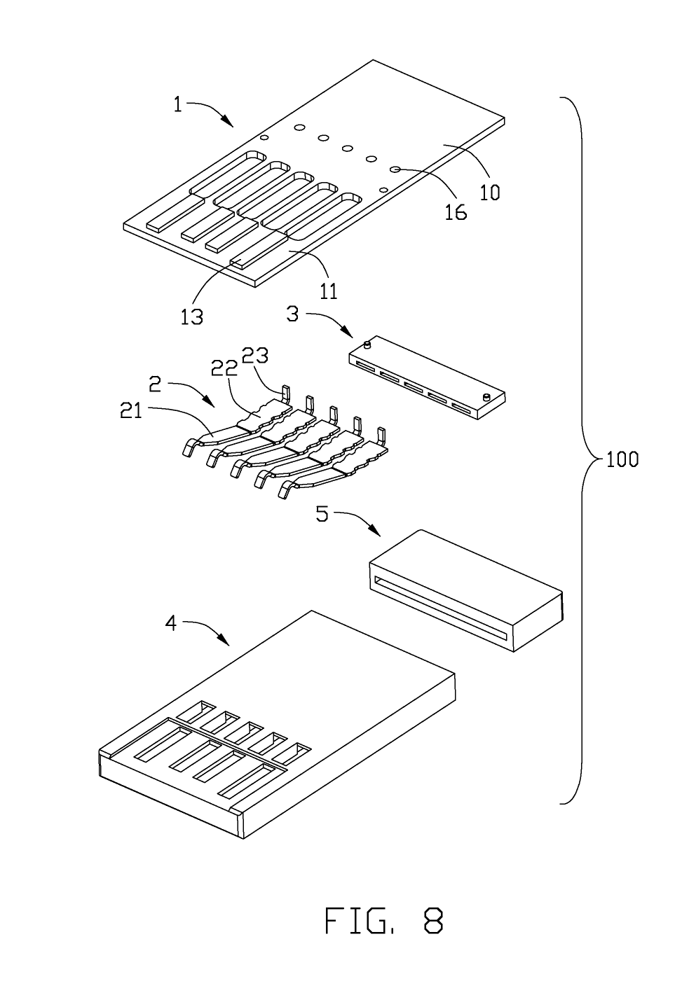

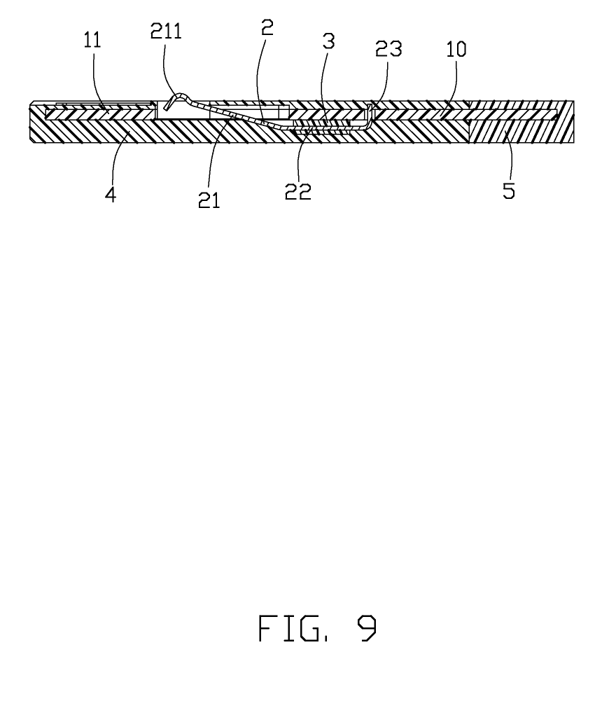

Referring to FIGS. 7-9, An USB memory card 100 according to a second embodiment of the present invention is disclosed and is much similar to the first embodiment. The differences between them are that the base portion 10 has a plurality of perforations 16 passing therethrough, the tail portions 23 bend upwardly from the rear ends of the corresponding connecting portions 22 and are mounted through the perforations 16 of the PCB 1, therefore, the tail portions 23 of the resilient contacts 2 are mounted to the base portion 10 of the PCB 1 by through hole technology (THT).

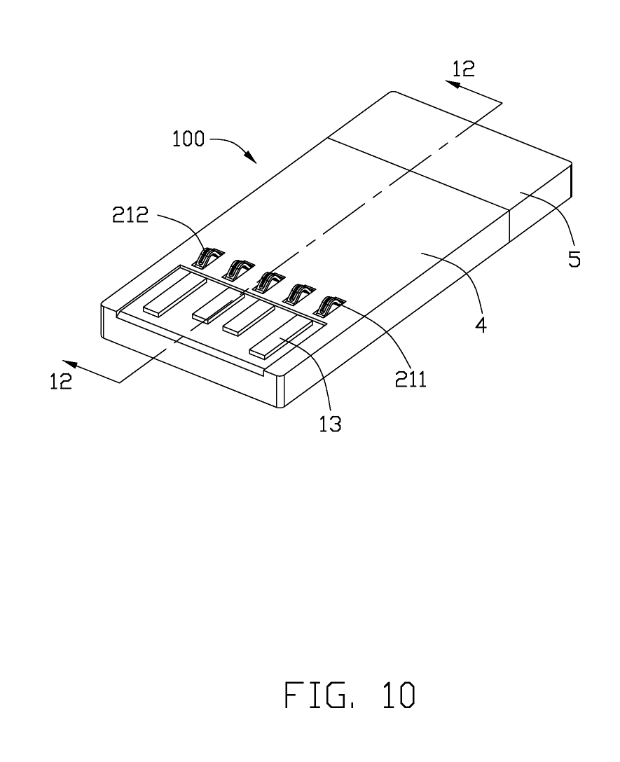

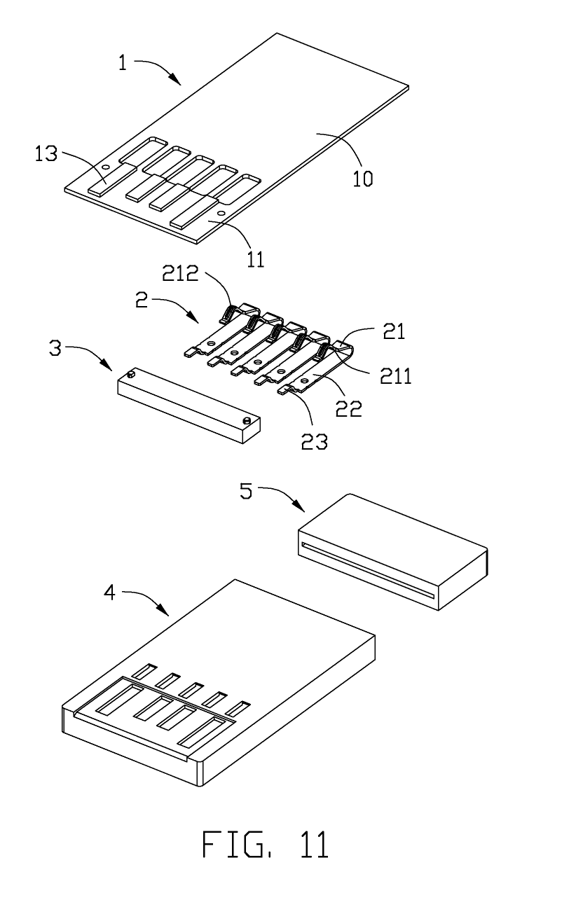

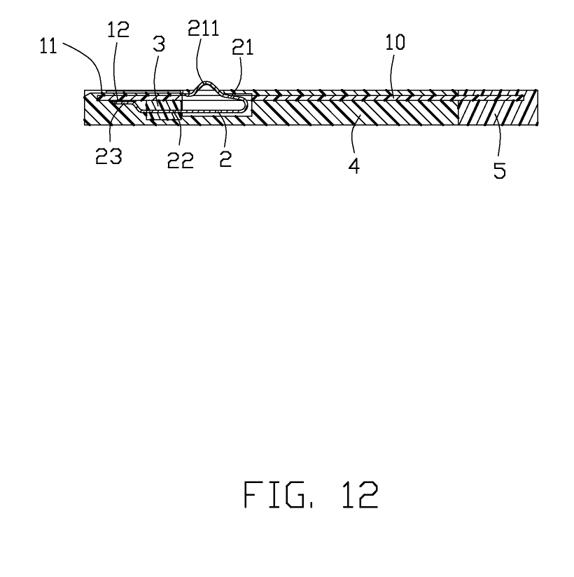

Referring to FIGS. 10-12, An USB memory card 100 according to a third embodiment of the present invention is disclosed. The differences between the first and third embodiments are that the soldering pads 12 are formed on a lower surface of the tongue portion 11, the tail portions 23 of the resilient contacts 2 bend upwardly and extend forwardly from the front ends of the connecting portions 22 so as to be soldered on the soldering pads 12 respectively, the contacting portions 21 of the resilient contacts 2 bending upwardly and extending forwardly from the rear ends of the connecting portions 22 so as to enhance their elastic force, each contacting portion 21 has a rib 212 formed on an upper surface of the arc portion 211 so that the contacting portions 21 could contacting with the receptacle connector reliably. The insulator 3 is located under the tongue portion 11 and between the soldering portions 12 and the passageways 14. In this third embodiment, the tail portions 23 of the resilient contacts 2 are mounted onto the tongue portion 11 of the PCB 1 by surface mount technology (SMT), therefore, the base portion 10 will have more spaces on its lower surface for disposing passive components or oscillators or other components, a length of the base portion along a front-to-back direction could be decreased so as to diminish the volume of the USB memory card 100.

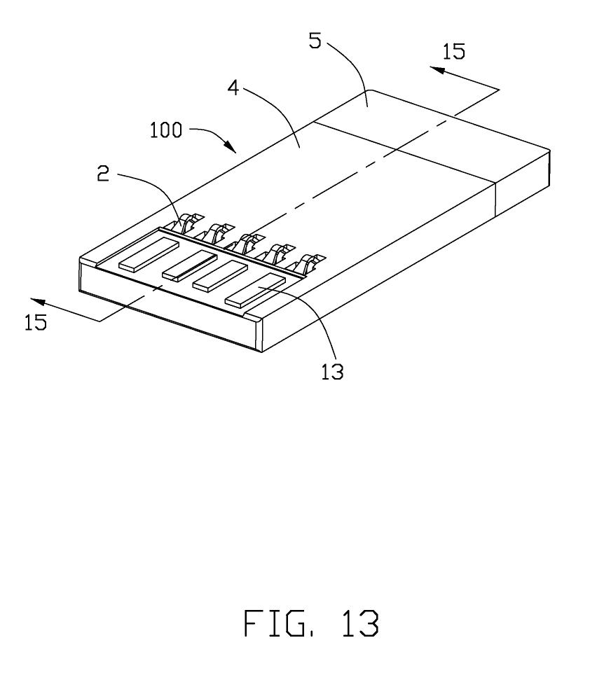

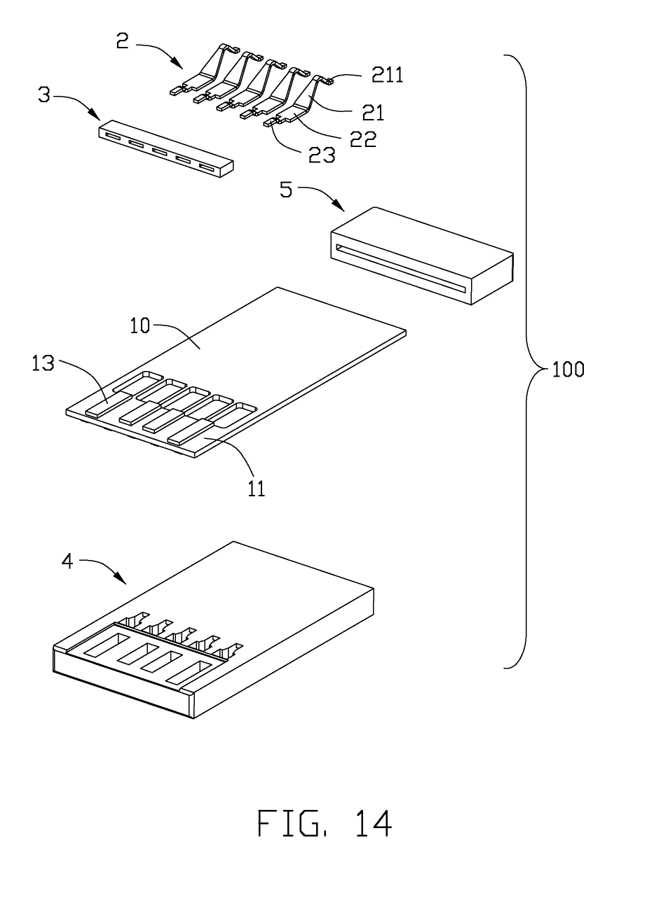

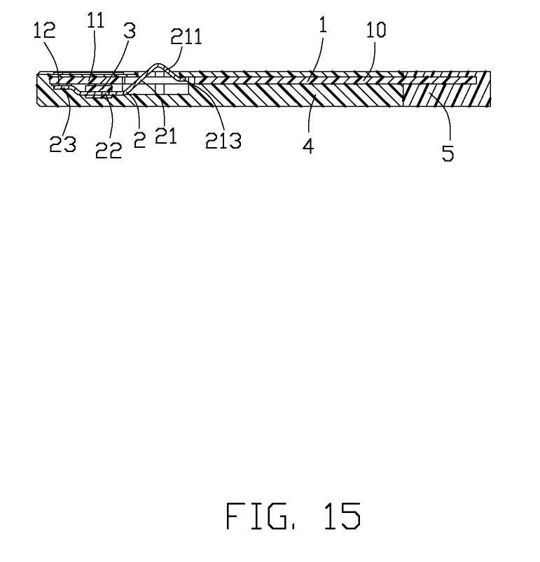

Referring to FIGS. 13-15, An USB memory card 100 according to a fourth embodiment of the present invention is disclosed. The differences between the first and fourth embodiments are that the soldering pads 12 are formed on a lower surface of the tongue portion 11, the tail portions 23 of the resilient contacts 2 bend upwardly and extend forwardly from the front ends of the connecting portions 22 to be soldered on the soldering pads 12 respectively, the contacting portions 21 of the resilient contacts 2 bending upwardly and extending backwardly from the rear ends of the connecting portions 22, the free end portions 213 are formed at rear ends of the arc portions 211 and are resisted downwardly by the shell 4. The insulator 3 is located under the tongue portion 11 and between the soldering portions 12 and the passageways 14. In this fourth embodiment, the tail portions 23 of the resilient contacts 2 are mounted onto the tongue portion 11 of the PCB 1 by surface mount technology (SMT), therefore, the base portion 10 will have more spaces on its lower surface for disposing passive components or oscillators or other components, a length of the base portion along a front-to-back direction could be decreased so as to diminish the volume of the USB memory card 100.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An USB memory card comprising:
a printed circuit board defining opposite first and second surfaces, the printed circuit board having a plurality of passageways passing through said first and second surfaces;
a plurality of metal contacting pads formed on the first surface of the printed circuit board and before said passageways in a front-to-back direction; and
a contact module including an insulator secured to the printed circuit board, and a plurality of resilient contacts defining resilient contacting portions for being movable in the corresponding passageways along a height direction of the USB memory card, tail portions for being mounted to the printed circuit board, and connecting portions connecting the contacting portions and the tail portions for being retained in the insulator.

2. The USB memory card according to claim 1, wherein the insulator has a plurality of cavities passing therethrough in the front-to-back direction, the connecting portions are assembled to the corresponding cavities.

3. The USB memory card according to claim 1, wherein the insulator is located behind the passageways in the front-to-back direction.

4. The USB memory card according to claim 3, wherein the insulator is located on the second surface of the printed circuit board, the contacting portions extend forwardly from front ends of the connecting portions and protrude into the passageways and beyond the first surface.

5. The USB memory card according to claim 4, wherein the tail portions are mounted onto a plurality of metal soldering pads which are formed on the second surface and located behind the passageways.

6. The USB memory card according to claim 4, wherein the tail portions are mounted through a plurality of perforations which pass through the first and second surfaces and located behind the passageways.

7. The USB memory card according to claim 1, wherein the insulator is located on the second surface of the printed circuit board and before the passageways, the tail portions extend forwardly from front ends of the connecting portions and are mounted onto a plurality of metal soldering pads which are formed on the second surface and located before the passageways to oppose the metal contacting pads.

8. The USB memory card according to claim 7, wherein the contacting portions bend over forwardly from rear ends of the connecting portions and protrude into the passageways and beyond the first surface.

9. The USB memory card according to claim 7, wherein the contacting portions extend backwardly from rear ends of the connecting portions and protrude into the passageways and beyond the first surface.

10. The USB memory card according to claim 1, wherein each contacting portion has an arc potion protruding beyond the first surface and defining a rib extending along the arc portion in the front-to-back direction.

11. The USB memory card according to claim 1, wherein the USB memory card further comprises a shell covering the printed circuit board and the contact module, the shell defines a depression recessed inwardly toward the first surface and passing through a front edge thereof, a plurality of first receiving slots formed on the depression for exposing the metal contacting pads to exterior, and a plurality of second receiving slots formed thereon and located behind the depression for exposing the contacting portions to exterior.

12. The USB memory card according to claim 11, wherein each contacting portion defines a free end portion at a free end thereof for being resisted by the shell.

13. An USB 3.0 thin card comprising:
a printed circuit board defining a base portion and a tongue portion extending forwardly from the base portion, the tongue portion having a plurality of metal contacting pads disposed on an upper surface thereof, and a plurality of passageways passing therethrough in a height direction of the USB 3.0 thin card and located behind the metal contacting pads in a front-to-back direction;
a contact module including an insulator disposed on a lower surface of the printed circuit board, and a plurality of resilient contacts comprising resilient contacting portions protruding upwardly into the corresponding passageways and beyond the upper surface of the printed circuit board, tail portions for being mounted to the printed circuit board, and connecting portions connecting the contacting portions and the tail portions for being retained in the insulator; and
a shell covering the printed circuit board and the contact module with the metal contacting pads and the contacting portions exposed to exterior.

14. The USB 3.0 thin card according to claim 13, wherein the insulator is located on a lower surface of the base portion and behind the passageways, the tail portions are mounted onto the lower surface of the base portion by surface mount technology (SMT) or through hole technology (THT).

15. The USB 3.0 thin card according to claim 13, wherein the insulator is located on a lower surface of the tongue portion and before the passageways, the tail portions extend forwardly from front ends of the connecting portions and are mounted onto the lower surface of the tongue portion by surface mount technology (SMT).

16. A thin card comprising:
a printed circuit board defining a front-to-back direction, a width direction perpendicular to said front-to-back direction, and a height direction perpendicular to both said front-to-back direction and said width direction;
opposite first and second surfaces respectively defined on the printed circuit board and spaced from each other in the height direction;
a plurality of conductive pads side by side disposed on the first surface adjacent to a front region thereof;
a plurality of openings side by side formed in the printed circuit board behind the conductive pads, each of said opening extending through both said first and second surfaces;
a contact module including an insulator to which a plurality of resilient secured under condition that the insulator is attached unto the printed circuit board so as to have the contacts extend from the second surface toward and beyond the first surface in said height direction.

17. The thin card as claimed in claim 16, wherein the insulator is located behind the openings in said front-to-back direction.

18. The thin card as claimed in claim 16, further including a shell enclosing said printed circuit board and defining two rows of through holes to expose the corresponding conductive pads and contacts.

19. The thin card as claimed in claim 16, wherein each of said contacts includes a tail mechanically and electrically connected to the second surface.

20. The thin card as claimed in claim 16, wherein said insulator is attached unto the second surface.
